(19) United States
(12) Patent Application Publication
(10) Pub. No.: US 2015/0169567 A1
(43) Pub. Date: Jun. 18, 2015

(54) SEARCH RESULT IMAGE DISPLAY ENVIRONMENT AND BACKGROUND

(71) Applicants: Anantica Jija Hari Singh, San Francisco, CA (US); Ziga Mahkovec, San Francisco, CA (US); Sashanka Vishnuvajhala, San Jose, CA (US); Nathan D. Beach, Sunnyvale, CA (US); Othar Hansson, Sunnyvale, CA (US)

(72) Inventors: Anantica Jija Hari Singh, San Francisco, CA (US); Ziga Mahkovec, San Francisco, CA (US); Sashanka Vishnuvajhala, San Jose, CA (US); Nathan D. Beach, Sunnyvale, CA (US); Othar Hansson, Sunnyvale, CA (US)

(73) Assignee: GOOGLE INC., Mountain View, CA (US)

(21) Appl. No.: 13/349,208

(22) Filed: Jan. 12, 2012

(51) Int. Cl. G06F 17/30

(52) U.S. Cl. CPC G06F 17/3028; G06F 17/30247; G06F 17/30864

(57) ABSTRACT

Methods, systems, and apparatus, including computer programs encoded on a computer storage medium, for processing image search results. In one aspect, a method includes displaying a page resource received in response to the selection of the image search result in a display environment belonging to a first domain of a server that hosts the page resource, generating an image display environment on the page resource, displaying an image resource referenced by the image search result in the image display environment, and in response to a command to close the image display environment, closing the image display environment and displaying the page resource.

### BACKGROUND

This specification relates to information presentation.

The Internet provides access to a wide variety of resources. For example, digital image files, video and/or audio files, as well as web pages for particular subjects or particular news articles, are accessible over the Internet. A variety of search engines are available for identifying particular resources accessible over the Internet. For example, digital images that satisfy a user's informational need can be identified by an image search process in which keywords or other data are processed to identify collections of digital images. Each image is identified to the user by an image search result. An image search result references a corresponding image resource that a search engine determines to be responsive to a search query, and typically includes a representative image of the image resource (such as a thumbnail). The image search result also references a page resource that includes the image resource.

### SUMMARY

Selection of an image search result causes the user device to request the page resource. Some search engines, however, present the image in an interstitial form instead of transitioning the browser to the page resource. For example, a search engine may cause a browser to render the page resource requested from a server that belongs to a particular domain in an iFrame that belongs to the domain of the search engine, and that is different from the domain of the server from which the page resource was requested. The image resource that is included in the page resource is rendered in an image overlay environment that is the top level page of the browser. This allows the user to view a version of the image that is larger than the version that is presented in the image search result, and also provides the user with some context of the page resource in which the image is displayed. However, should the user close the image overlay environment to view the underlying page resource, the iFrame that is being used to display the page resource is also closed. Accordingly, the browser issues another request to the server hosting the page resource. This specification describes technologies relating to processing image search results in a manner in which the display of the page resource is maintained.

In general, one innovative aspect of the subject matter described in this specification can be embodied in methods that include the actions of monitoring for a selection of one of a plurality of image search results displayed in a search results page, each image search result referencing a corresponding image resource that is determined to be responsive to a search query and including a representative image of the image resource, and referencing a page resource that includes the image resource, and wherein a selection of an image search result causes the user device to request the page resource; in response to a selection of one of the image search results: displaying the page resource received in response to the selection of the image search result in a display environment belonging to a first domain of a server that hosts the page resource, generating an image display environment on the page resource, displaying the image resource in the display environment, and in response to a command to close the display environment, closing the display environment and displaying the page resource. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. The subject matter of this application solves the technical problem of minimizing requests to a server hosting a page resource resulting from the selection of an image search result that references the page resource. In particular, by presenting the image in a display environment that is a child or otherwise hierarchically subordinate to page resource, e.g., in an iFrame that is a child of the page resource, the closing of the display environment does not, in turn, close the display environment of the page resource. Accordingly, a subsequent request for the page resource need not be generated, thereby reducing latency inherent in the re-rendering of the page resource. This also makes for a more fluid user experience, as the user may transition his or her attention directly from the image in the display environment to the page resource underlying the display environment without being distracted by the re-rendering of the page resource.

Additionally, server traffic metrics are not artificially inflated by duplicate requests resulting from the user selections of image search results, thereby readily facilitating more accurate web traffic reporting and web traffic analytics.

Also, the system can automatically scroll to a section of a web page that contains the image resource referenced by a search result that is selected by a user. Often an image that is relevant to the user's query is “below the fold” of the web page, and is not displayed in an active viewport when positioned at the top of the page. The automatic scrolling benefits users by not requiring them to scroll down to find the image as it appears on the page.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in image search results are processed.

FIGS. 2A-2C are illustrations of example user interfaces presented during the processing of an image search result.

FIGS. 3A and 3B are illustrations of additional example user interfaces presented during the processing of an image search result.

FIG. 4 is a flowchart of an example process for processing an image search result.

FIG. 5 is a flowchart of an example process for generating an overlay image display environment.

FIG. 6 is an illustration of example user interface in which the image display environment is presented inline.

Like reference numbers and designations in the various drawings indicate like elements.

### DETAILED DESCRIPTION

### Overview

An image search result includes a representation of an image, the URL of the image, and the URL of a web page that includes the image. The representation of the image, can, for example, be a scaled version of the image, such as a thumbnail. The image search result is shown on an image search results page in a user device application, such as a browser.

The browser includes instructions that are executed by the user device. The instructions cause the browser to monitor for a selection of an image search result. In response to monitoring the selection of an image search result, the browser requests the web page that includes the image referenced in the image search result. Additionally, the instructions cause the browser to create an image display environment in addition to the web page and in which the image is displayed. Example of the image display environment includes an overlay image display environment that is rendered atop the web page in the browser (i.e., with precedence with respect to the web page), and an inline image display environment that is displayed within the webpage.

In some implementations, the image overlay is an iFrame that belongs to the domain of a search engine and that is placed on the web page. The top level page of the browser is the requested web page, which belongs to a domain of a server that served the web page. The iFrame is populated with the image that is referenced by the search result, and, optionally, metadata describing additional information about the image, the web site that includes the web page, and other data.

In some implementations, the browser also monitors for an event that signals that the source of the page resources can be processed to locate the image in the page resource. Examples of such an event include an onload event, a DOM ready event, etc. In response to monitoring the event, the browser searches the web page source to locate the image within the web page. For example, the browser may search for image files or URLS that reference image files and that are denoted by HTML elements. Such HTML elements include image tags, anchor tags, HREF tags, and the like. For each image file or URL referencing an image file that is found, the system determines whether the referenced image file matches the image file referenced by the image search result. If a match is found, the instructions cause the browser to scroll to the image so that the image is in an active portion of the viewport. Thus, should the user close the iFrame or collapse the inline image display environment, the user is presented with the portion of the web page that includes the image.

The processing of the image search results is described in more detail below.

Example Environment

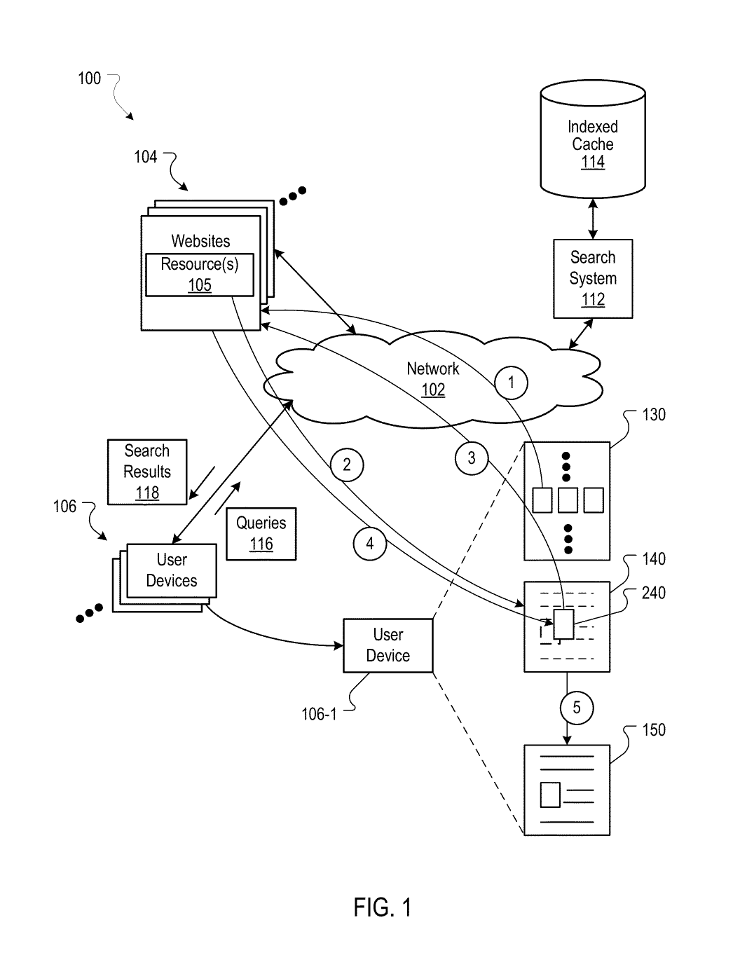

FIG. 1 is a block diagram of an example environment 100 in which systems implementing the subject matter of this written description are implemented. A network 102, such as a local area network (LAN), a wide area network (WAN), the Internet, or a combination thereof, connects websites 104, user devices 106, and a search engine 112.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource 105 can be any data that can be provided over the network 102. A resource 105 can be identified by a resource address that is associated with the resource 105. Resources include HTML pages, images, portable document format (PDF) documents, videos, and feed sources, to name only a few. Additionally, resources such as web page resources can, in turn, reference other resources such as images so that when the web page resource is rendered on a user device, the referenced image is also displayed.

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102. By use of these applications, a user device 106 can request resources 105 from a website 104. In turn, the resource 105 can be provided to the user device 106 for presentation by the user device 106.

To facilitate searching of these resources, a search system 112 identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

For images, the search system 112 utilizes image processing algorithms to identify multiple instances of the same image. The search system 112, in some implementations, then selects a representative image (e.g., a canonical image) that is used to represent each of the identical images, and associates the representative image with each of the underlying identical images. The underlying web page that is referenced in the image search result is determined at query time, as a particular query may include information that results in one particular web page being selected over other web pages that include the same image.

At query time, the user devices 106 submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. Each search result page typically includes multiple search results.

Processing Image Search Results

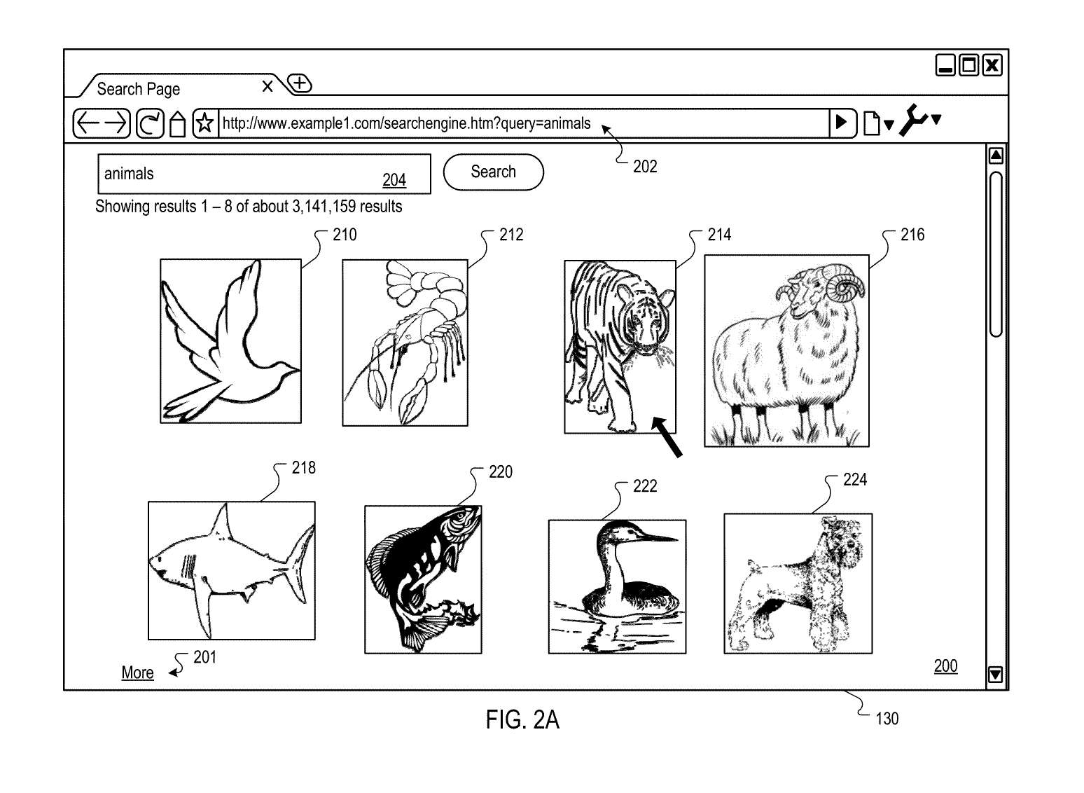

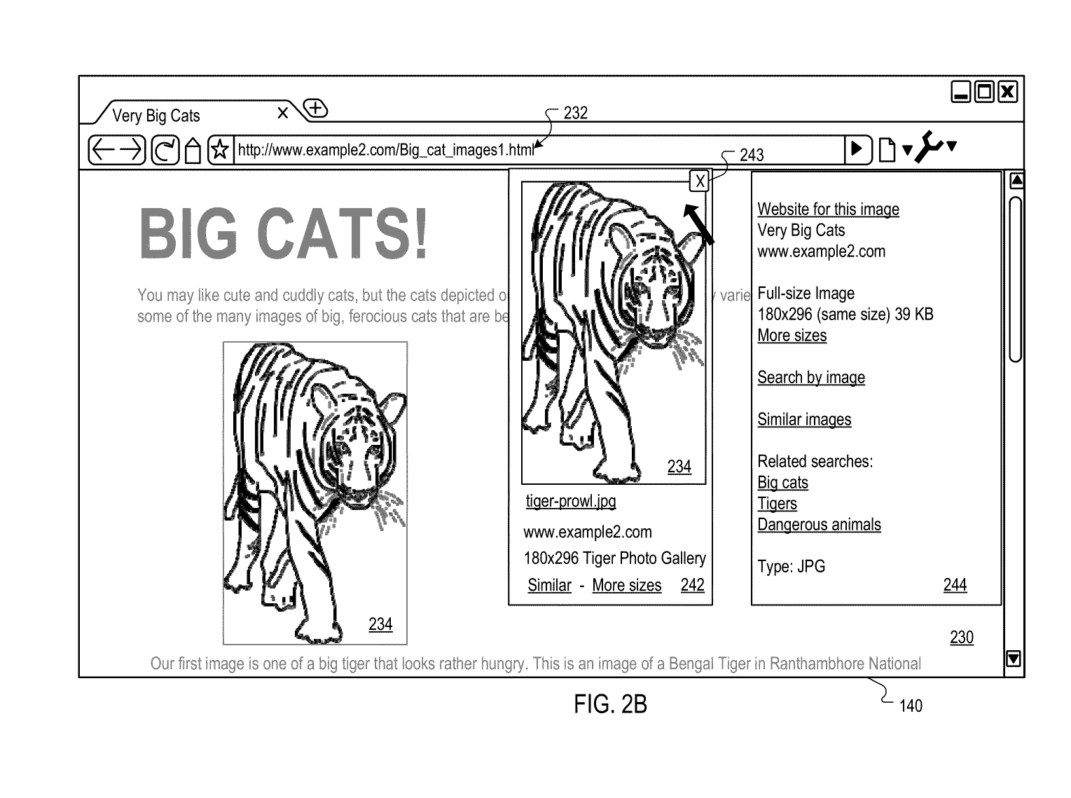

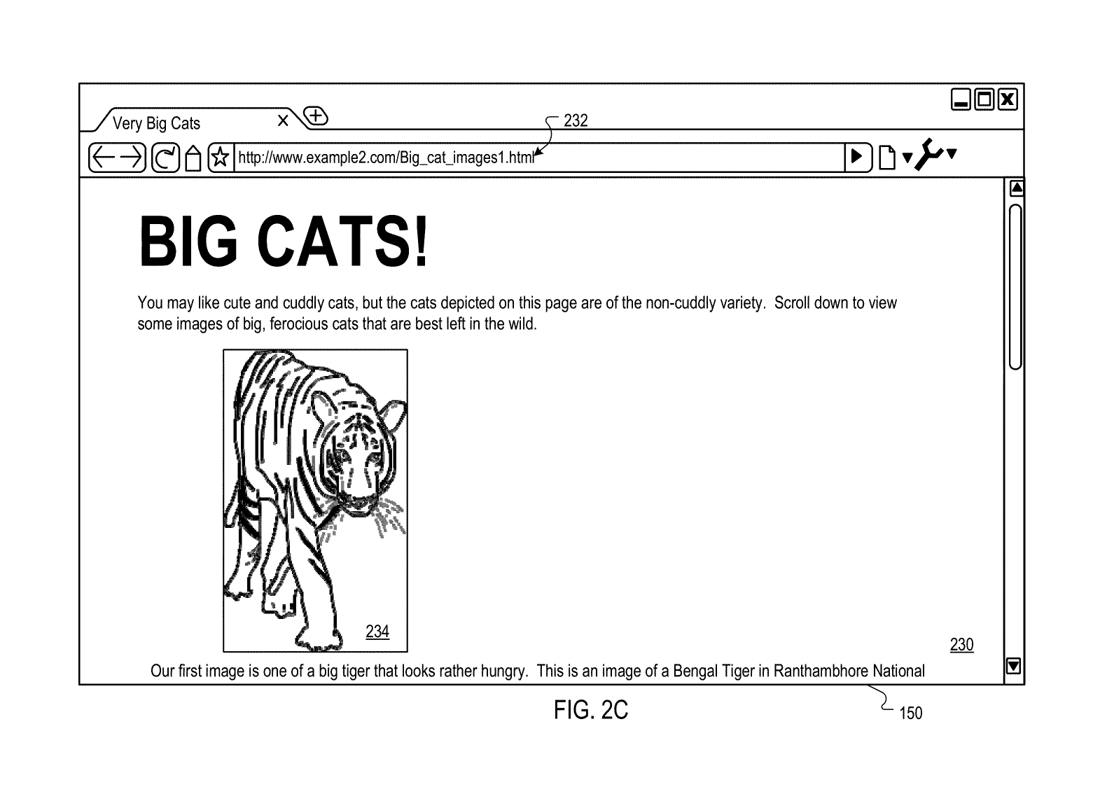

The processing of image search results on a user device is depicted with reference to the user device 106-1 and the three user interface representations 130, 140 and 150. The three user interface representations 130, 140 and 150 depict the progression from an image search results page to an underlying page resource that includes an image referenced in a selected search result. The user interface representations 130, 140 and 150 are shown in more detail in FIGS. 2A-2C, which are illustrations of the example user interfaces 130, 140 and 150 presented during the processing of an image search result.

In response to a query, the search system 112 provides search results 118 to the user device 106-1. As depicted in the user interface 130 in FIG. 2A, the user device 106-1 is displaying a search results page 200. The example URL 202 represents the URL of the search results page 200 served by the search system 112. In response to the query 204 “animals”, the search system 112 has provided image search results 210, 212, 214, 216, 218, 220, 222 and 224. Each image search result references a corresponding image resource that is determined to be responsive to a search query and includes a representative image of the image resource. For example, each image shown in the search results page 200 may be a smaller version of a corresponding image provided by a website 104. Each search result references a page resource 105 that includes the image resource. The page resource may, in some situations, be the same as the image resource; however, most often the page resources is, for example, an HTML page that references the image resource so that when the HTML page is rendered on a user device, the image is displayed with additional content.

Additional image search results may be made available by selecting the “More” link 201, or, alternatively, by scrolling down the search results page 200 to change the active portion of the viewport. As shown in the user interface 130, the user has positioned the cursor over the image search result 214.

In some implementations, the browser application running on the user device 106-1 includes instructions that facilitate the processing of search results as described in more detail below. The instructions can be provided in a variety of different ways. For example, the instructions can be part of the browser executable, or alternatively can be provided by a browser plug-in, a toolbar application, or even provided in the form of a script with the search results page 200.

In operation, the instructions cause the user device 106-1 to monitor for a selection of one of the image search results displayed in the search results page 200. The selection of an image search result causes the user device 106-1 to request the page resource referenced by the search result. For example, assume the user selects the image search result 214. As depicted in FIG. 1, the selection causes the user device 106-1 to send a request for the page resource reference by the search result. The request is denoted by data flow element 1 in FIG. 1.

In response, the server hosting the requested page resource serves the page resource to the user device 106-1, as denoted by data flow element 2 in FIG. 1. Additionally, the instructions executing on the user device cause the user device to create an image display environment 240 on the page resource, and the image that is referenced by the search result is displayed within the image display environment 240. For example, in some implementations, the image display environment on the page resource is an image overlay environment, such as an iFrame. The iFrame is instantiated such that it is a child of the page resource, e.g., by use of the instructions:

var iframe = document.createElement(‘iframe’);
document.body.appendChild(iframe)

The iFrame is thus hierarchically subordinate to the page resource, e.g., the page resource is the top-level page of the browser. Once instantiated, the image resource is requested for the overlay environment, as denoted by data flow element 3 in FIG. 1. In response to the request, the server hosting the image resource provides the image resource to the user device 106-1, as denoted by data flow element 4 in FIG. 1. The image display environment 240 displays the image resource and is the top level element in the browser on the user device 106-1.

The resulting user interface 140 is shown in detail in FIG. 2B. The page resource 230, referenced by the URL address 232, is rendered subordinate to the image display environment 240, i.e., the image display environment 240 is displayed such that the display of the page resource is subordinate in terms of vertical stacking. In FIG. 2B, the overlay environment includes a first portion 242 in which the image resource 234 and image metadata are displayed, and a second portion 244 in which additional metadata are displayed. The image resource 234 is the image resource referenced by the image search result 214, and which is also shown in the page resource 230. The image resource 234 may itself be addressed by a URL that is different from the page resource 230 URL 232. For example, the URL of the image resource may be “www.example2.com/tiger-prowl.jpg.” In some implementations, in addition to the metadata, the first portion 242 of the overlay environment may include links to similar images and different versions of the image 234. Selection of a link may, for example, cause the search system 112 to perform corresponding operations, such as identifying similar images and images of different sizes.

The second portion 244 of the image overlay environment includes additional metadata for the image 234, such as the website hosting the image 234, image size data, links to additional images, similar images, and additional search options. Additional metadata and commands (or fewer commands and metadata) can also be shown.

While the first and second portions 242 and 244 are depicted as separate elements, they are, in some implementations, elements of the same iFrame. In variations of these implementations, the portions 242 and 244 need not be rendered in separate areas, and the portions 242 and 244 can be combined such that the image 234, metadata and commands are shown in a contiguous portion.

In the first portion 242 of the image display environment 240 a close command 243 is displayed. Selection of the close command closes the image display environment 240, and as a result the page resource 230 is displayed as the top level page. The closing of the image display environment 240 is depicted by data flow element 5 of FIG. 1, and the resulting user interface 150 is shown in detail in FIG. 2C.

In some implementations, the iFrame belongs to a domain of the search system 112 server that served the image search results to the user device 106. Usually this domain is different from the domain of the server that served the page resource 230. However, because the iFrame is a child of the page resource, closing the iFrame does not close the display of the page resource 230. Accordingly, a subsequent request to the server hosting the page resource 230 is not required, thereby eliminating the need for duplicate requests.

In FIGS. 2B and 2C, the image 234 is located at the top of the page resource. Often, however, an image that is referenced by an image search result is not located at the top of a page resource, and the user must “scroll down” the page resource to find the image. In these situations, the initial display of the page resources does not provide the full context of the image within the page resource. Thus, in some implementations, the instructions executing on the user device 106 cause the user device to determine a location of the image resource within the page resource, and, once the location is determined, navigate to the location of the image resource within the displayed page resource such that upon closing the overlay environment a portion of the page resource that includes the image resource is displayed.

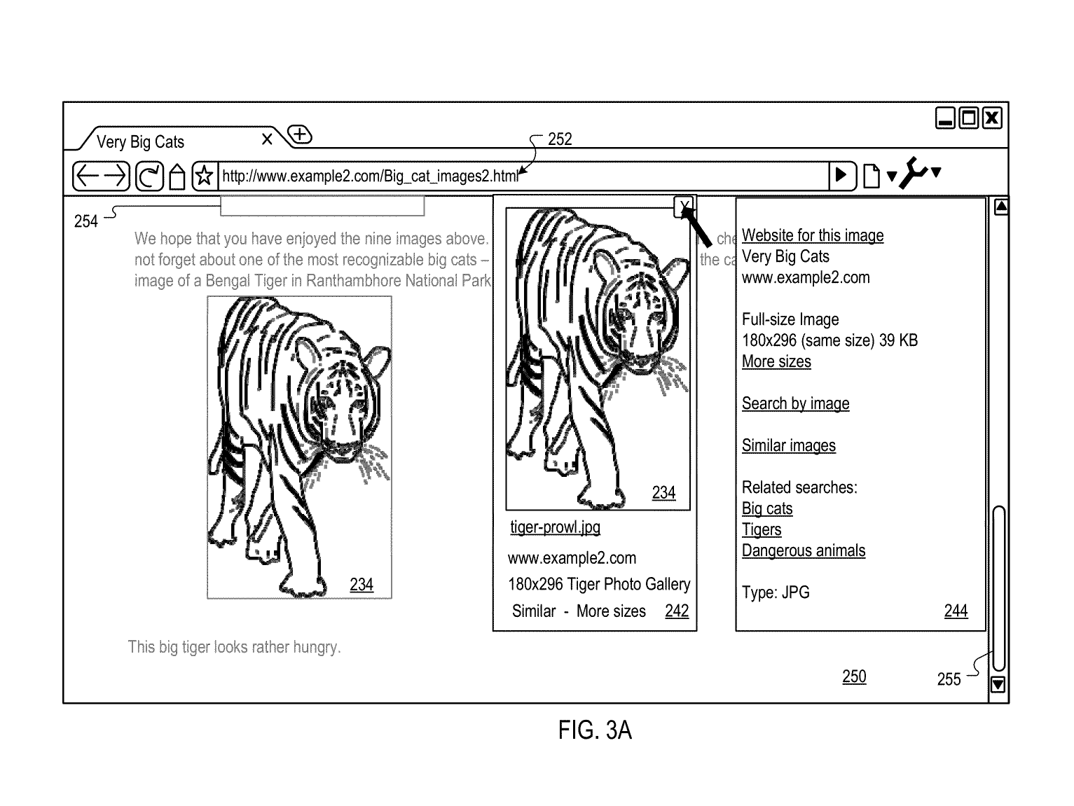

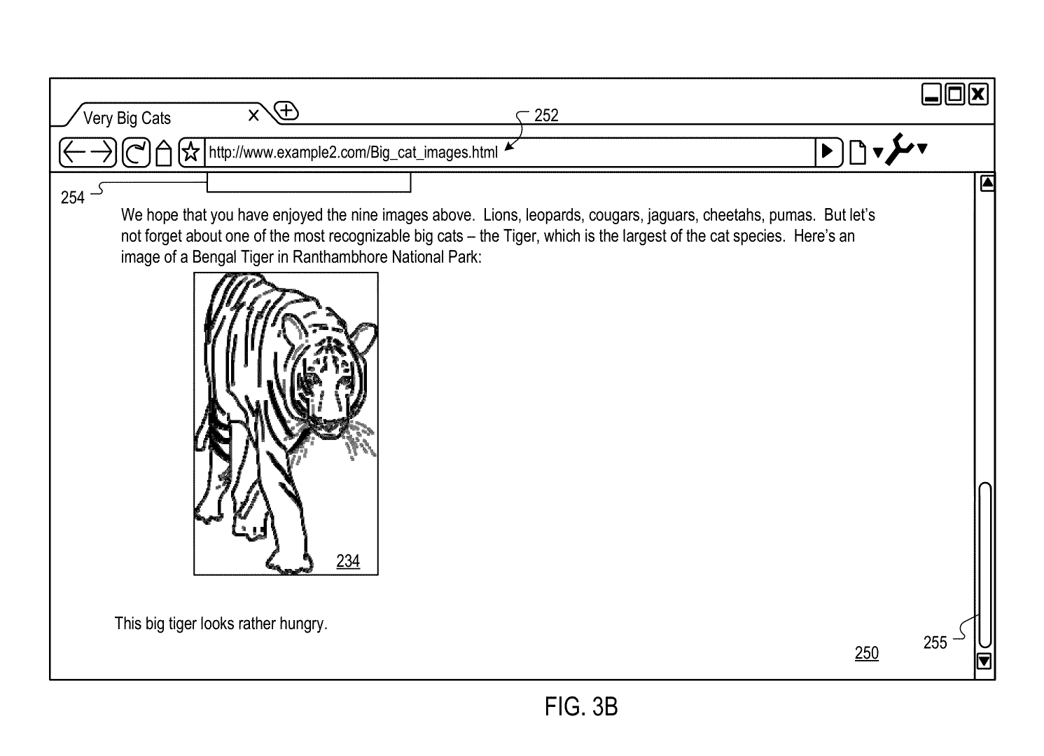

FIGS. 3A and 3B are illustrations of additional example user interfaces presented during the processing of an image search result and in which the automatic navigation to the portion of a page resource 250 that includes the image is illustrated. The page resource 250 differs from the page resource 230 in that the image 234 is located at the bottom of the page resource 250. For example, in the page resource 250, the bottom portion 254 of another image is shown in the viewport, and the scroll position indicator 255 indicates that the view port is at the bottom of the page resource 250.

As shown in FIG. 3A, the browser has navigated to the portion of the page resource that includes the image 234. To accomplish this function, in some implementations, the instructions can cause the user device to identify where in the page resource the image is located. Once located, the instructions automatically scroll the browser to that portion of the page resource. For example, the user device may search HTML elements of the page resource to identify HTML elements that indicate an image file resource address. For example, the browser may search for image files or URLS that reference image files that are denoted by image tags, anchor tags, HREF tags, and the like. For each image file or URL referencing an image file found, the user device determines whether the referenced image file matches the image file referenced by the image search result. If a match is found, the instructions cause the browser to scroll to the image so that the image is in an active portion of the viewport. Thus, should the user close the iFrame or collapse the inline image display environment, the user is presented with the portion of the web page that includes the image, as shown in FIG. 3B.

In some implementations, the browser monitors for an event that signals that the source of the page resource can be processed to locate the image in the page resource. Examples of such an event include an onload event, a DOM ready event, etc. In response to monitoring the event, the browser searches the web page source to locate the image within the web page, as described above.

Example Processes

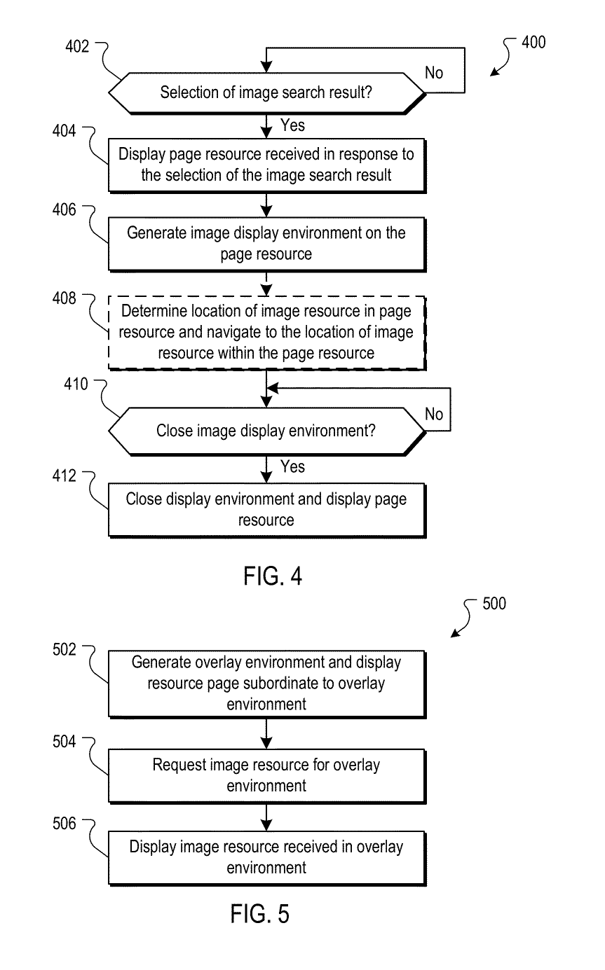

FIG. 4 is a flowchart of an example process 400 for processing an image search result. The process 400 can be implemented in a user device 106 executing instructions that cause the user device to perform the operations described below.

The process 400 monitors for the selection of an image search result (402). For example, the user device may monitor for the selection of a search result, e.g., as indicated by an onClick event on an image, or some other event indicative of the selection.

In response to monitoring the selection of an image search result, the process 400 displays the page resource received in response to a resulting request for the page resource (404). The process 400 also generates an image display environment on the page resource (406). For example, as depicted in FIG. 2B, the image resource 230 is displayed subordinate to the image overlay environment 240.

The process 400 optionally determines a location of the image resource in the page resource and navigates to the location of the image resource within the page resource (408). For example, as describe with reference to FIG. 3A, the user device 106 may search HTML elements of the page resource to identify elements that indicate an image file resource address. For each image file or URL referencing an image file found, the user device determines whether the referenced image file matches the image file referenced by the image search result. If a match is found, the instructions cause the browser to scroll to the image so that the image is in an active portion of the viewport.

The process 400 monitors for a command to close the image display environment (410), and in response to monitoring the command, the process 400 closes the image display environment and displays the page resource (412).

FIG. 5 is a flowchart of an example process 500 for generating an overlay image display environment. The process 500 can be implemented in a user device 106 executing instructions that cause the user device to perform the operations described below.

The process 500 generates an overlay environment and displays a resource page subordinate to the overlay environment (502). For example, as depicted in FIG. 2B, the user device generates an iFrame in which the image overlay environment 240 is displayed, and the image resource 230 is displayed subordinate to the image overlay environment 240.

The process 500 requests an image resource for the overlay environment (504). For example, the user device 106 requests the image resource referenced by the image search result for display in the image overlay environment. Once the image resource is received, the process 500 displays the image resource received in the overlay environment (506).

Additional Features and Variations

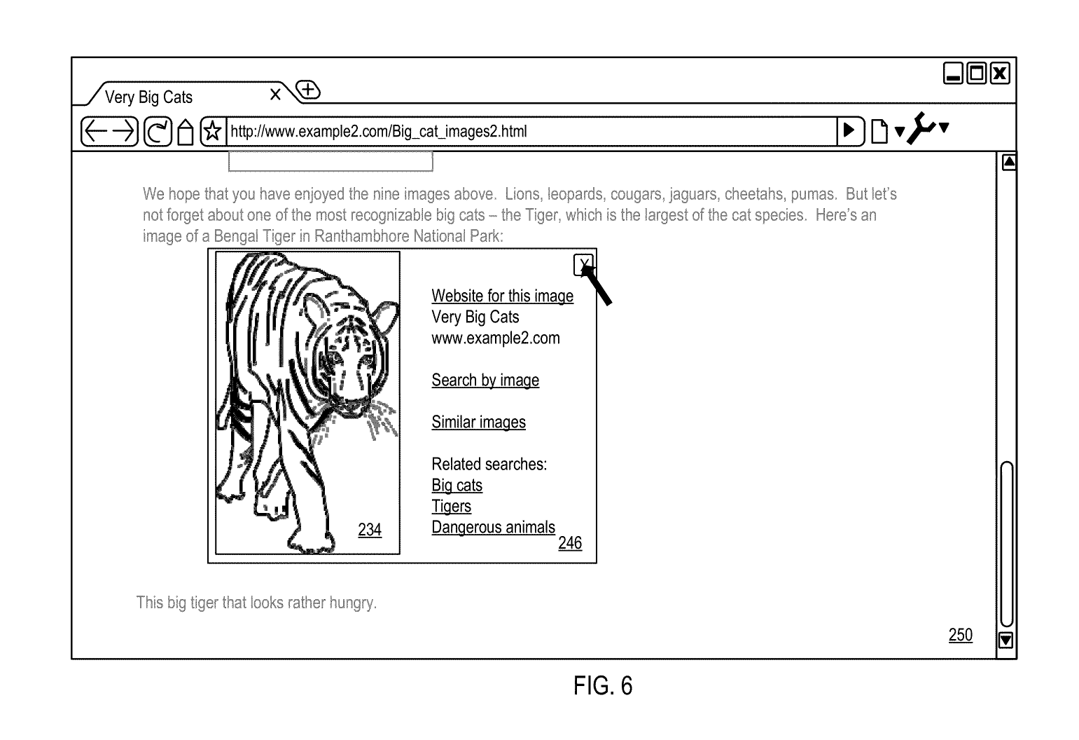

The implementations described above are examples of processing image search results, and the features and aspects for such processing are not limited to the examples described above. For example, other types of image display environments can also be used. FIG. 6 is an illustration of an example user interface in which the image display environment 240 is presented inline. In particular, a metadata interface box 246 is displayed adjacent to the image 234 inline with the page resource 250, i.e., at a portion of the page resource that includes the image resource. This can be accomplished, for example, by writing appropriate HTML instructions and elements into the DOM tree of the page resource 250. The metadata interface box 246 can include metadata about the image 234 and commands similar to those described above with respect to portions 242 and 244 in FIGS. 2A and 2B. Closing the metadata interface box 246 causes the page resource 250 to become the top level resource displayed in the browser.

Although specific examples have been described in the context of textual search queries, any type of user interface and image search algorithm can be used. For example, image search queries in the form of actual images can be used. Alternatively, voice input can be used to input text queries or to specify specific images as image queries.

Furthermore, the specific user interface features are merely examples of user interface environments in which the features described herein can be used. The features can also be adapted to many other user interface environments.

Although specific example have been described in the context of image search operations, the features can be applied to any type of search result for any corpus in which a portion of a resource of interest is to be shown in context with the underlying resource referenced by the search result.

Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A non-transitory computer storage medium encoded with instructions that when executed by a user device cause the user device to perform operations comprising:
displaying a plurality of image search results in a search results page received from a search engine server that belongs to a search engine domain, each image search result referencing a corresponding image resource that is determined to be responsive to a search query and including a representative image of the image resource, and referencing a page resource that includes the image resource, and wherein a selection of an image search result causes the user device to request the page resource from a server that hosts the page resource;
in response to a selection of one of the image search results:
sending, from the user device and to a first server hosting the page resource referenced by the image search result, a request for the page resource, wherein the first server belongs to a first domain that is different from the search engine domain;
displaying the page resource received in response to the request as a top level page belonging to the first domain in a display environment belonging to the first domain of the first server that hosts the page resource;
generating an image display environment on the page resource;
displaying the image resource in the image display environment; and
in response to a command to close the image display environment, closing the image display environment and displaying the page resource received in response to the request as the top level page belong to the first domain and without a subsequent request from the user device to the first server for the page resource.

2. The non-transitory computer storage medium of claim 1, wherein:
generating the image display environment on the page resource comprises generating an image overlay environment on the page resource, wherein the display of the page resource is subordinate to the display of the image overlay environment; and
displaying the image resource in the image display environment comprises:
requesting, for the overlay environment, the image resource referenced by the selected image search result and that is included in the page resource; and
in response to receiving the image resource, displaying the image resource in the image overlay environment.

3. The non-transitory computer storage medium of claim 2, wherein generating the image overlay environment on the page resource comprises generating an image overlay environment in an iFrame.

4. The non-transitory computer storage medium of claim 3, wherein generating the image overlay environment in the iFrame comprises generating an iFrame belonging to a second domain of a search engine server that served the image search results to the user device.

5. The non-transitory computer storage medium of claim 3, wherein the instructions cause the user device to perform further operations comprising:
determining a location of the image resource within the page resource; and
navigating to the location of the image resource within the displayed page resource such that upon closing the image overlay environment a portion of the page resource that includes the image resource is displayed.

6. The non-transitory computer storage medium of claim 5, wherein determining the location of the image resource within the page resource comprises:
searching for HTML elements of the page resource that indicate an image file resource address;
comparing the image file resource address indicated by the HTML elements to an image file resource address of the image resource; and
in response to determining that the image file resource address indicated by the HTML elements matches the image file resource address of the image resource, navigating within a display viewport to the portion of the page resource that includes the image resource.

7. The non-transitory computer storage medium of claim 1, wherein:
generating the image display environment on the page resource comprises generating an inline display environment on the page resource, the inline display environment displaying the image resource and being displayed at a portion of the page resource that includes the image resource; and
displaying the image resource in the image display environment further comprises displaying within the inline display environment image metadata of the image resource.

8. A method performed by a data processing apparatus, comprising:
displaying, by a data processing apparatus, a plurality of image search results in a search results page received from a search engine server that belongs to a search engine domain, each image search result referencing a corresponding image resource that is determined to be responsive to a search query and including a representative image of the image resource, and referencing a page resource that includes the image resource, and wherein a selection of an image search result causes the user device to request the page resource from a server that hosts the page resource;
in response to a selection of one of the image search results:
sending, from the user device and to a first server hosting the page resource referenced by the image search result, a request for the page resource, wherein the first server belongs to a first domain that is different from the search engine domain;
displaying, by the data processing apparatus, the page resource received in response to the request as a top level page belonging to the first domain in a display environment belonging to the first domain of the first server that hosts the page resource;
generating, by the data processing apparatus, an image display environment on the page resource;
displaying, by the data processing apparatus, the image resource in the image display environment; and
in response to a command to close the image display environment, closing the image display environment and displaying the page resource received in response to the request as the top level page belonging to the first domain and without a subsequent request from the user device to the first server for the page resource.

9. The method of claim 8, wherein:
generating the image display environment on the page resource comprises generating an image overlay environment on the page resource, wherein the display of the page resource is subordinate to the display of the image overlay environment; and
displaying the image resource in the image display environment comprises:
requesting, for the overlay environment, the image resource referenced by the selected image search result and that is included in the page resource; and
in response to receiving the image resource, displaying the image resource in the image overlay environment.

10. The method of claim 9, wherein generating the image overlay environment on the page resource comprises generating an image overlay environment in an iFrame.

11. The method of claim 10, wherein generating the image overlay environment in the iFrame comprises generating an iFrame belonging to a second domain of a search engine server that served the image search results to the user device.

12. The method of claim 10, further comprising:
determining a location of the image resource within the page resource; and
navigating to the location of the image resource within the displayed page resource such that upon closing the image overlay environment a portion of the page resource that includes the image resource is displayed.

13. The method of claim 12, wherein determining the location of the image resource within the page resource comprises:
searching for HTML elements of the page resource that indicate an image file resource address;
comparing the image file resource address indicated by the HTML elements to an image file resource address of the image resource; and
in response to determining that the image file resource address indicated by the HTML elements matches the image file resource address of the image resource, navigating within a display viewport to the portion of the page resource that includes the image resource.

14. The method of claim 8, wherein:
generating the image display environment on the page resource comprises generating an inline display environment on the page resource, the inline display environment displaying the image resource and being displayed at a portion of the page resource that includes the image resource; and
displaying the image resource in the image display environment further comprises displaying within the inline display environment image metadata of the image resource.

15. A system, comprising:
a data processing apparatus; and
a computer storage medium encoded with instructions that when executed by the data processing apparatus cause the data processing apparatus to perform operations comprising:
displaying a plurality of image search results in a search results page received from a search engine server that belongs to a search engine domain, each image search result referencing a corresponding image resource that is determined to be responsive to a search query and including a representative image of the image resource, and referencing a page resource that includes the image resource, and wherein a selection of an image search result causes the user device to request the page resource from a server that hosts the page resource;
in response to a selection of one of the image search results:
sending, from the user device and to a first server hosting the page resource referenced by the image search result, a request for the page resource, wherein the first server belongs to a first domain that is different from the search engine domain;
displaying the page resource received in response to the request as a top level page belong to the first domain in a display environment belonging to the first domain of the first server that hosts the page resource;
generating an image display environment on the page resource;
displaying the image resource in the image display environment; and
in response to a command to close the image display environment, closing the image display environment and displaying the page resource received in response to the request as the top level page belonging to the first domain and without a subsequent request from the user device to the first server for the page resource.

16. The system claim 15, wherein:
generating the image display environment on the page resource comprises generating an image overlay environment on the page resource, wherein the display of the page resource is subordinate to the display of the image overlay environment; and
displaying the image resource in the image display environment comprises:
requesting, for the overlay environment, the image resource referenced by the selected image search result and that is included in the page resource; and
in response to receiving the image resource, displaying the image resource in the image overlay environment.

17. The system of claim 16, wherein generating the image overlay environment on the page resource comprises generating an image overlay environment in an iFrame.

18. The system of claim 17, wherein generating the image overlay environment in the iFrame comprises generating an iFrame belonging to a second domain of a search engine server that served the image search results to the user device.

19. The system of claim 17, wherein the instructions cause the data processing apparatus to perform further operations comprising:
determining a location of the image resource within the page resource; and
navigating to the location of the image resource within the displayed page resource such that upon closing the image overlay environment a portion of the page resource that includes the image resource is displayed.

20. The system of claim 19, wherein determining the location of the image resource within the page resource comprises:
searching for HTML elements of the page resource that indicate an image file resource address;
comparing the image file resource address indicated by the HTML elements to an image file resource address of the image resource; and
in response to determining that the image file resource address indicated by the HTML elements matches the image file resource address of the image resource, navigating within a display viewport to the portion of the page resource that includes the image resource.

21. The system claim 15, wherein:
generating the image display environment on the page resource comprises generating an inline display environment on the page resource, the inline display environment displaying the image resource and being displayed at a portion of the page resource that includes the image resource; and
displaying the image resource in the image display environment further comprises displaying within the inline display environment image metadata of the image resource.
